(19) United States
(12) Patent Application Publication
(10) Pub. No.: US 2024/0149518 A1
(43) Pub. Date: May 9, 2024

(54) METHOD FOR INSPECTING A CONTAINER MADE OF PLASTICS MATERIAL AND MACHINE FOR MANUFACTURING SUCH A CONTAINER

(71) Applicant: SIDEL PARTICIPATIONS, OCTEVILLE-SUR-MER (FR)

(72) Inventor: Mikaël DERRIEN, OCTEVILLE-SUR-MER (FR)

(21) Appl. No.: 17/773,265

(22) PCT Filed: Oct. 28, 2020
(86) PCT No.: PCT/EP2020/080212

§ 371 Date: Apr. 29, 2022

(30) Foreign Application Priority Data
Oct. 30, 2019 (FR) FR1912174

(51) Int. Cl. B29C 49/78; B29C 49/80; B29L 31/00

(52) U.S. Cl. CPC B29C 49/786; B29C 49/80; B29C 2049/7868; B29C 2049/7882; B29L 2031/7158

(57) ABSTRACT

The invention relates to a method for inspecting a container (2) made of plastic material obtained by molding, the method comprising:
a step of capturing a thermal image of the container (2) on leaving the mold (31);
a step of characterization of the container (2), in which a rule for acceptance or rejection of the quality of the container (2) is applied, as a function of the thermal image of the container (2) on leaving the mold (31),
   wherein, prior to the characterization step, the method comprises a step of identification, on the thermal image, of at least critical zone corresponding to a structural part of the container (2),
   and wherein the acceptance rule is parameterized to consider a container (2) as acceptable if, for each identified critical zone, the temperature of the container is lower than a predetermined threshold temperature.

The field of the invention is that of the design and the production of machines for manufacturing containers made of plastic material.

More specifically, the invention relates to a method for inspecting containers made of plastic material obtained by molding.

Containers made of plastic material are conventionally obtained from preforms heated to a glass transition temperature at which the plastic material is softened and easily deformed.

Once heated, the preforms are introduced into a forming unit comprising blowing stations each comprising at least one mold in order to blown therein by injection of air and follow the form of a mold which gives them their final form.

When the containers are manufactured, they are inspected in order to determine that they have the right strength for their future use.

Several inspecting methods currently exist.

A first method, by sampling, consists in cutting up the container and in measuring the various thicknesses at different points of the container, notably to check the minimal presence of material affording the container adequate strength.

This is particularly useful when the containers are intended to contain carbonated drinks, that is to say drinks including carbon dioxide that pressure the container when it is plugged.

The containers must therefore withstand the pressure and not break under the effect thereof. The thickness of the containers makes it possible to check the strength.

Now, when a container is checked according to this first method, it is then unusable. It is also known that the quality of a container depends largely on the quality of the preform.

So, such a sampling-based method does not make it possible to significantly guarantee the quality of the containers produced.

Another known method consists in checking the thickness of the walls of the container directly on leaving the forming unit by a method comprising:
a step of capturing a technical image of the container on leaving the mold;
a step of characterization of the container in which a rule for acceptance or rejection of the quality of the container is applied, as a function of the thermal image of the container on leaving the mold.

Reference can for example be made to the patent documents published under the numbers EP 0 643 297 and EP 0 177 004.

Such a method is, however, restrictive, and does not allow adaptation to all the containers.

Moreover, such a method does not make it possible to precisely determine the reasons for the rejection of a container.

Finally, such a method can allow a container to be used and therefore considered as acceptable with respect to the thickness of its walls, without the latter truly corresponding to a predetermined geometry making it possible to withstand forces such as the internal pressure for example.

Indeed, simply by measuring the thickness of the walls, it is possible to confirm only the presence or the absence of a minimal thickness of material, without the geometrical forms being inspected.

The containers do in fact have particular forms such as grooves, feet or bosses, allowing flexible or, on the other hand, rigid zones to be created, to withstand in particular the internal pressure of the carbonated drinks, the depressurization or even vertical or horizontal loads on the containers.

There are therefore certain cases in which a container may be marketed even though it is nonconformal or defective.

Now, the introduction of a nonconformal packaging on the rest of the bottling line can lead to label placement defects, packaging defects, deformations or collapses of pallets of containers for example.

These defects may be observed as far as the distribution centers, where deformed or malformed bottles can also be damaging to the brand image and therefore the marketing thereof.

The objective of the invention is notably to mitigate the drawbacks of the prior art.

More specifically, the objective of the invention is to propose a nondestructive method for inspecting containers made of plastic material obtained by molding, making it possible to increase the quality inspection of the containers manufactured and avoid in particular any risk of acceptance of a container that should be rejected.

Another objective of the invention is to provide such a method which allows a manufacturing operator to be able to adjust the manufacturing parameters or, at the very least, be made aware of the cause of a production failure.

Yet another objective of the invention is to provide such a method which allows, if need be, feedback on the process of manufacturing the molds and in particular the geometry thereof, which gives the containers their final form.

Another objective of the invention is to make it possible to reduce the energy consumption needed to manufacture containers, notably by making it possible to reduce the blowing pressures compared to the standard methods. In fact, obtaining the high pressures necessary to the blowing requires significant energy consumption, notably electrical energy consumption, to operate the compressors. Reducing the blowing pressure therefore goes hand-in-hand with reducing energy consumption.

These objectives, and others which will emerge hereinbelow, are achieved by virtue of the invention, the subject of which is a method for inspecting a container made of plastic material obtained by molding, the method comprising:
a step of capturing a thermal image of the container on leaving the mold;
a step of characterization of the container, in which a rule for acceptance or rejection of the quality of the container is applied, as a function of the thermal image of the container on leaving the mold,
   wherein, prior to the characterization step, the method comprises a step of identification, on the thermal image, of at least one critical zone corresponding to a structural part of the container,
   and wherein the acceptance rule is parameterized to consider a container as acceptable if, for each identified critical zone, the temperature of the container is lower than a predetermined threshold temperature.

By virtue of this method, it is possible to optimize the inspection time, but also the quality of the inspection.

Indeed, by identifying critical zones, it is possible to inspect only those particular zones to allow a container to be characterized as acceptable or not.

Thus, the image capturing and container characterization times are greatly reduced compared to a conventional method.

Furthermore, contrary to a method according to a method of the prior art, by focusing on the critical zones, it is possible to check the conformity of a container, in as much as said critical zones correspond to particular geometrical zones of the container, developed notably to withstand internal pressures, depressurizations, or even vertical and/or horizontal loads.

Furthermore, the use of the predetermined threshold temperature makes it possible to check that the container is correctly formed. This check is done both in terms of quality and of observance of a manufacturing specification.

In fact, when a container is correctly formed, most of the plastic material has come into contact with the walls of the mold according to a precise contact time. At the very least, most of the zones deemed as critical, because they are functional in the packaging, have come into contact with the walls of the mold according to a precise contact time.

During the contact between the plastic material and the mold, the former is cooled down to reach a mold leaving temperature which is within a known restricted range.

Thus, when the temperature of the container is compared with the predetermined threshold temperature, it is possible to determine whether the plastic material has or has not entered into contact with the walls of the mold and, if it has, whether it has remained in contact with the walls of the mold for long enough to be suitably cooled.

A plastic material cooled too little therefore remains malleable, which presents a risk of deformation of the container and therefore a lack of resistance to the pressure of the container. The deformation of the container then begins immediately after the degassing step, that is to say after the pressure resulting from the blowing into the container has dropped to ambient pressure (generally atmospheric pressure), which takes place after the forming of the container in the conventionally known manufacturing methods.

The combination of the identification of the critical zones and of the temperature of the formed container makes it possible to check that, at strategic points of the container, the latter will be able to withstand, for example, an internal pressure generated by its contents (carbonated drinks for example) or an external pressure such as a top load pressure, that occurs when containers are packaged or palletized, or other types of stresses.

In fact, for example, in the case of filling with carbonated drinks, certain zones of the containers, very little subject to the pressure forces of the carbonated drink, do not thus need to be inspected.

Nor do other zones for which the resistance functionality is not essential to the bottling line or to the intrinsic characteristics of the packaging thus need to be inspected.

According to a preferred embodiment, the predetermined threshold temperature lies between 45° C. and 75° C.

Such a range of values makes it possible to consider as acceptable containers whose temperature does not exceed said range of values. That therefore makes it possible to offer a fairly broad inspection and acceptance tolerance.

Preferably, the predetermined threshold temperature is 60° C.

This temperature, considered as the maximum temperature of the container on leaving the mold, makes it possible to ensure a mechanical strength of the container after the latter has left the mold. Beyond that temperature, the mechanical strength cannot be guaranteed.

Advantageously, the method comprises a step of generation of an alert to an operator in the case of identification of a container considered as unacceptable.

Such an alert makes it possible to attract the attention of the operator in order for the latter to follow the progress of the manufacturing of the containers on the machine, and notably the progress of the containers manufactured from the mold from which the leaving container generated the alert.

Thus, it is possible to conclude either on a failure at one of the blowing stations (whether it be a failure of the mold associated with the station concerned or failure of another component associated with a blowing station, such as a solenoid valve), when some or all of the containers declared nonconformal leave one and the same blowing station or, on an overall failure of the machine, when the containers declared nonconformal leave different blowing stations, or even on a preform manufacturing defect or a transient failure, for example when a single container is declared nonconformal.

Thus, through their tracking, the operator can take the decision to modify the manufacturing method, notably the preform heating conditions, the different blowing pressures and the compressed air injection or degassing times, act directly by deactivating a blowing station if the latter is defective, stop production in case of overall failure or even contribute to improving the development of the molds to make it possible to obtain containers of less complex forms or, on the contrary, more complex containers for which it is desirable to improve the properties in order to make them resistant to higher internal pressures, for example.

Preferably, the step of capturing a thermal image of the container on leaving the mold is performed within a time interval less than or equal to 5 seconds from the end of the container degassing step, which occurs on completion of the manufacturing of the container. The end of this step corresponds to the instant when the internal pressure of the container resulting from the blowing has dropped back to ambient pressure, which internal pressure is permanently monitored.

Such an interval avoids having the container cool too much on contact with the ambient air on leaving the mold.

In fact, when a container leaves the mold in which it was manufactured, it immediately enters into contact with the ambient air of the container manufacturing machine, this air generally being between 10° C. and 40° C.

By considering that a container generally has walls that have a thickness of the order of 25 hundreds of a millimeter, the cooling of the zones that are malformed or that have had a very short time of contact with the mold is very rapid, which prevents the detection of defects by thermal imaging beyond the interval previously described.

Even more preferentially, the step of capturing a thermal image of the container made of plastic material on leaving the mold is performed within a time interval less than or equal to 0.6 seconds from the end of the container degassing step.

This restricted interval offers more guarantees as to the correct progress of the container inspection method, and notably of the step of capturing a thermal image of the container.

The invention relates also to a machine for manufacturing containers made of plastic material, wherein it comprises:
a forming unit for forming the containers with at least one blowing station comprising at least one mold;
thermal image acquisition means positioned at the output of the forming unit;
a computing unit, connected to the thermal image acquisition means, the computing unit being parameterized to implement the method as previously described.

Such a machine therefore makes it possible to perform direct inspection of the containers on leaving the forming unit, and do so in order to facilitate the inspection step and limit the impact on the production or, on the contrary, act rapidly on the progress of the manufacturing method to limit the risks of scrapped containers.

Preferably, the thermal image acquisition means comprise a thermal camera.

The thermal camera, positioned at the output of the forming unit, makes it possible to obtain a thermal image of the container in order to easily inspect the quality thereof through the method as previously described.

Furthermore, such a thermal camera can offer a fairly low nominal definition that does however make it possible to perform a precise and qualitative inspection.

Advantageously, the forming unit comprises a plurality of blowing stations, each with at least one mold for the forming of the containers, the computing unit being parameterized to associate each container with one of the molds, and generate an alert to an operator in case of a container considered as unacceptable, said alert notably including association information making it possible to determine in which of the molds of the forming unit (therefore in which of the blowing stations) a container considered as unacceptable was manufactured.

Thus, it is possible to track the progress of one of the blowing stations in particular that may exhibit a defect for example, so as to check, precisely, the quality of each container formed by said station or, on the contrary, eliminate the activity of said station, notably by deactivating it during the manufacturing cycles.

Furthermore, that makes it possible to precisely track the various container manufacturing steps, which increases the traceability and therefore the quality of the containers.

According to a preferential embodiment, the machine also comprises a dialogue interface with an operator, the dialogue interface allowing the display of the alert generated by the computing unit.

This dialogue interface then ensures visibility and display of information for the operator, the latter being able, via the dialogue unit, to track the manufacturing in real time, modify the manufacturing parameters applied at one or more blowing stations or, finally, validate and confirm to the computing unit that the issue is a single defective container, not compromising the manufacturing of the other containers.

Other features and advantages of the invention will become more clearly apparent on reading the following description of a preferential embodiment of the invention, given as an illustrative and nonlimiting example, and the attached drawings, in which:

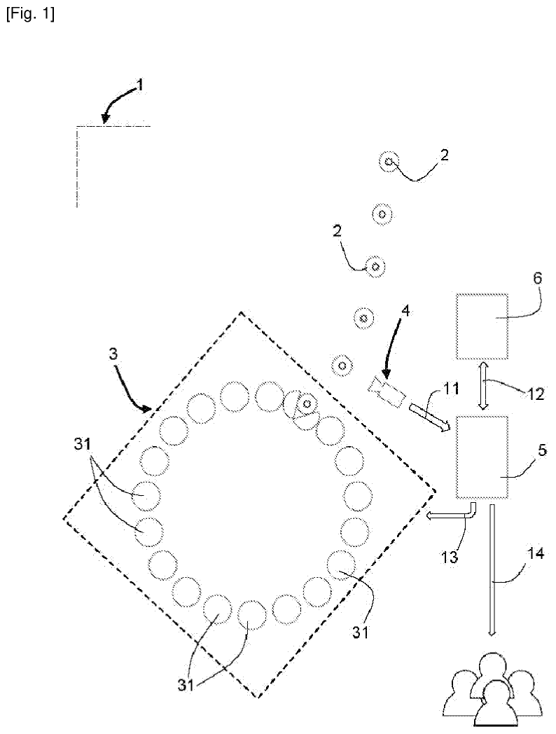

FIG. 1 is a schematic view of a container manufacturing machine according to the invention;

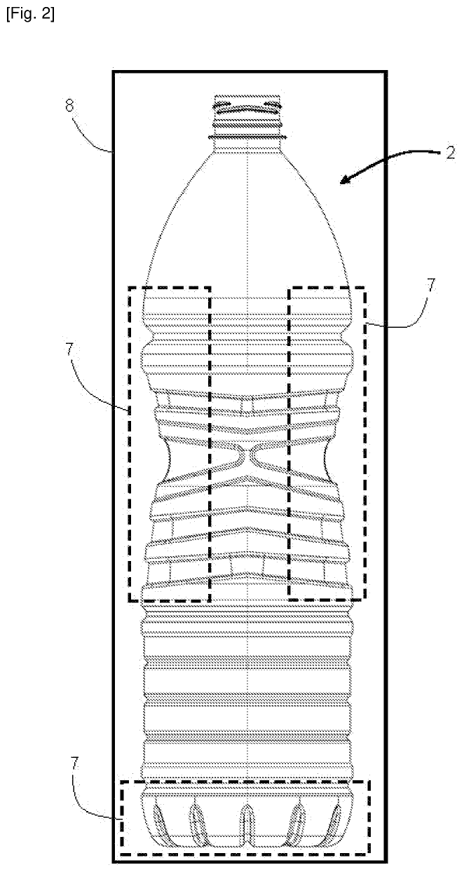

FIG. 2 is a schematic view of a filter applied to a thermal image of a container obtained from the manufacturing machine of FIG. 1, upon the implementation of the inspection method by the computer unit of the machine.

Referring to FIG. 1, a machine 1 for manufacturing containers 2 according to the invention comprises:
a forming unit 3 for forming the containers 2, comprising a plurality of blowing stations, each with at least one mold 31 intended to form a container 2 in a final form of use;
acquisition means 4 for acquiring a thermal image of the containers 2 formed by the forming unit 3;
a computing unit 5;
a dialogue interface 6.

In the interests of simplification, unless a greater semantic precision is necessary, in the rest of the description, the term “mold” will be considered as equivalent to the term “blowing station”.

The containers 2 are advantageously made of plastic material such as PET (polyethylene terephthalate) for example.

The acquisition means 4 for acquiring a thermal image are positioned at the output of the forming unit 3 and advantageously comprise a thermal camera.

The thermal camera is parameterized to take an instantaneous thermal image of a container 2 at the output of the forming unit 3 and transfer said thermal image to the computing unit 5.

The computing unit 5 is connected to the acquisition means 4 and is parameterized to implement a method for inspecting the containers 2 obtained by molding in the forming unit 3, in order to characterize the containers 2 as acceptable or unacceptable for their final use.

The method comprises:
a step of capturing a thermal image of the container 2 on leaving the mold 31;
a step of characterization of the container 2.

The capturing step is performed by the thermal image acquisition means 4 and makes it possible to obtain, as illustrated in FIG. 2, a thermal image of a formed container 2. The thermal image is then transmitted by the acquisition means 4 to the computing unit 5 as illustrated by the arrow 11 in FIG. 1.

For reasons of clarity, FIG. 2 does not illustrate the temperature gradients of the container 2.

This capturing step is performed within a time interval of less than or equal to 5 seconds from the end of the step of degassing of the container 2, which occurs on completion of the manufacturing thereof. The end of this step corresponds to the instant at which the internal pressure of the container, which drops back from the blowing pressure, arrives at ambient pressure, which internal pressure is monitored permanently during the successive manufacturing steps. Such a method for manufacturing containers 2 is widely known in this technical field.

This short time interval avoids having the container 2 cool excessively on contact with the ambient air on leaving the mold.

Considering that a container generally has walls that have a thickness of the order of 25 hundreds of a millimeter, excessive cooling of the container 2 will prevent the identification of thermal gradients on the thermal image of the container 2.

Preferentially, the step of capturing a thermal image of the container 2 on leaving the mold 31 is performed within a time interval less than or equal to 0.6 seconds from the end of the step of degassing of the container 2.

During the step of characterization of the container 2, a rule for acceptance or rejection of the quality of the container 2 is applied as a function of the thermal image of the container 2 on leaving the mold 31.

More particularly, with reference to FIGS. 1 and 2, prior to this characterization step, and notably to the application of the acceptance or rejection rule, the computing unit 5 transforms the thermal image obtained by the acquisition means 4.

For that, the computing unit 5 performs a step of identification, on the thermal image, of at least one critical zone 7 corresponding to a structural part of the container 2.

The critical zones 7 are, for example, zones of bosses or of striations making it possible to produce structural reinforcements of the container 2, or even the bottom of the container 2 which concentrates most of the stresses of the container 2 when the latter encloses a carbonated drink.

More specifically, the computing unit 5, for each thermal image, applies a mask 8 covering the thermal image, this mask 8, as illustrated in FIG. 2, has target zones defining the critical zones 7 of the container.

In other words, the mask 8 comprises windows identifying particular parts of the container 2, that have to exhibit minimum strength characteristics.

In fact, in their use, the containers 2 are subjected to various stresses, either internal, such as an internal pressure, which is for example the case for the containers 2 containing gassy or carbonated drinks, or external on the bottling lines or in the distribution sites.

In all these cases, the containers 2 are subjected to stresses for which formation defects can be critical, from a technical point of view. Formation defects can also be of an esthetic nature, particularly on zones which could prejudice the quality perceived by the consumer, which can directly affect the sales levels of the products. The appearance of manufacturing defects on the containers 2 is particularly notable in the production lines on which the packaging blowing pressure is reduced and optimized to the maximum, that is to say on most of the lines now present and almost all of the future lines.

The identification of the critical zones has the effect of limiting the computation time and notably the extent of the application of the acceptance or rejection rule to just these critical zones 7.

The computing unit 5 therefore uses the identified critical zones 7 in which it applies the acceptance or rejection rule.

Said acceptance rule is then parameterized to consider a container as acceptable if, for each identified critical zone 7, the temperature of the container 2 in said zone is lower than a predetermined threshold temperature.

According to a preferential embodiment, the predetermined threshold temperature lies between 40° C. and 75° C.

Preferably, the predetermined threshold temperature is 60° C.

Thus, when, in the critical zones 7, the temperature of the container 2 recorded by the thermal image is higher than the predetermined threshold value, then the container 2 is rejected and considered as unacceptable.

On the other hand, if the temperature is lower than the predetermined threshold temperature, and is so for each critical zone 7, then the container 2 is considered as acceptable.

A temperature higher than the predetermined threshold temperature can result from a lack of contact between the constitutive material of the container 2 and the walls of the mold 31.

In fact, during the contact between the plastic material of the container 2 and the walls of the mold 31, the plastic material tends to be cooled.

Consequently, if there is no contact between the plastic material and the mold 31, or if the contact is not marked enough, that is to say is too short, then the container can be incompletely formed and the plastic material not cooled down enough, which can provoke deformation of the affected zones because they are still too malleable, when the container 2 is removed from its manufacturing mold 31.

Furthermore, certain details of the container 2, such as reinforcing grooves, may not be correctly created on the final container 2, which limits the mechanical strength thereof.

The method is applied for each of the containers 2 leaving the forming unit 3.

The computing unit also makes it possible to associate each of the molds 31 with each container 2 leaving the forming unit 3.

More specifically, when a container 2 leaves the forming unit 3, the computing unit 5 allows a user, as explained hereinbelow, to know in which mold 31, and therefore in which blowing station, the container 2 concerned was produced.

For that, the user uses the dialogue interface 6. The interchanges between the computing unit 5 and the dialogue interface 6 are illustrated schematically by the arrow 12 in FIG. 1.

More particularly, in the case of an unacceptable container 2, the method via the computing unit 5, is parameterized to generate an alert setpoint which is transmitted by the computing unit 5 to the dialogue interface 6.

The operator can then consult the dialogue interface 6 and become aware of the alert setpoint.

This alert setpoint notably presents information on the container 2 considered to be unacceptable, as well as on the critical zone or zones 7 which made it possible to characterize the container 2 as being unacceptable, and finally on the mold 31 from which said container 2 came.

In the case of an alert, the operator can then track the manufacturing of the containers 2 by the mold 31 from which the unacceptable container 2 came.

Several particular cases are thus possible.

In a first case, the most advantageous, a single container 2 is considered as unacceptable, in which case the defects of the formed container 2 originate from a factor other than the production parameters, for example from a defect in the structure of the preform that gave the container 2.

Consequently, only the defective container 2 is scrapped, the rest of the production being considered as acceptable.

In a second case, the operator can detect a fault in the manufacturing of the containers 2 by one or more of the molds 31, therefore one or more of the blowing stations, of the manufacturing unit 3.

The invention can therefore make it possible to reveal:
a failure at one of the blowing stations, for example the failure of a mold 31 or of another component, such as a solenoid valve, associated with a blowing station, or the premature wear of this mold or other component, when several or all of the containers declared nonconformal leave the same mold 31, therefore the same blowing station, or
a failure in the application of the manufacturing setpoints of the containers 2, or
a defect in the manufacturing of a preform or a transient failure, for example when a single container is declared nonconformal.

The operator can then choose to lock out the defective blowing station or stations and therefore obtain a degraded mode of production, in which one or more molds 31 are not used, or to correct, for said suspect blowing stations, the manufacturing parameters.

On the other hand, in the case of an excessive number of defective blowing stations, the operator can decide to preventively stop production in order to avoid a complete failure of the machine 1 or even an excessive loss of production, before reconsidering a complete parameterization of the machine 1 or another corrective measure.

Finally, if a single blowing station is defective, the operator can choose to modify the production parameters just for this defective station.

The setpoints chosen by the operator are therefore transmitted to the forming unit 3 from the dialogue interface 6 via the computing unit 5, as illustrated by the arrows 12 and 13 in FIG. 1.

As a variant, in the case of totally automated production, the computing unit can, without intervention from the operator, generate a production rectifying setpoint to one or more blowing stations.

Preferably, such automation can be subject to validation by the operator in the context of excessive modification of the production setpoints.

In a third case, in which none of the containers 2 is acceptable but the manufacturing parameters are observed, the user may determine a problem in the design of the containers 2, notably their form.

That can prove useful when designing a container with a new form.

It is then possible to perform a retro-engineering step for example to structurally modify the molds, or, on the contrary, modify the form of the containers, as illustrated schematically by the arrow 14 in FIG. 1.

Such a manufacturing method and machine 1 therefore make it possible to obtain a precise characterization as to the acceptance or rejection of a formed container 2, and do so from a thermal image. In fact, it is known that, in some cases, containers are considered as acceptable only with respect to their material thickness, but these containers present a risk either in terms of mechanical strength on leaving the mold, or in terms of resistance to mechanical stresses during the use or marketing thereof.

Generally, the critical zones 7 of the thermal image can be analyzed either all at the same time, or independently one after the other.

Finally, as set out in the aims of the invention, this method makes it possible to achieve a reduction in energy consumption, since it makes it possible to optimize, by reducing, the pressures necessary to the blowing, while maintaining optimal production quality.

In fact, the trend is to reduce manufacturing times and pressures for the blowing of the containers made of PET.

Consequently, these conditions impose manufacturing at the limit of the acceptable quality tolerances for the containers made of plastic material.

This method therefore makes it possible to limit the risks of defects of the containers without degrading the production rates and while offering the possibility of modifying the container and/or manufacturing characteristics.

1. A method for inspecting a container (2) made of plastic material obtained by molding, the method comprising:
capturing a thermal image of the container (2) on leaving the mold (31);
identifying, on the thermal image, of at least one critical zone (7) corresponding to a structural part of the container (2), and
characterizing the container (2), in which a rule for acceptance or rejection of the quality of the container (2) is applied, as a function of the thermal image of the container (2) on leaving the mold (31),
wherein the acceptance rule is parameterized to consider a container (2) as acceptable if, for each identified critical zone (7), the temperature of the container is lower than a predetermined threshold temperature.

2. The method as claimed in claim 1, wherein the predetermined threshold temperature is between 45° and 75°.

3. The method as claimed in claim 1, wherein the predetermined threshold temperature is 60°.

4. The method as claimed in claim 1, further comprising generating an alert to an operator if a container (2) considered as unacceptable is identified.

5. The method as claimed in claim 1, wherein the capturing a thermal image of the container (2) on leaving the mold (31) is performed within a time interval less than or equal to 5 seconds from the end of the step of degassing of the container (2), which occurs on completion of the manufacturing of the container (2).

6. The method as claimed in claim 5, wherein the capturing a thermal image of the container (2) on leaving the mold (31) is performed within a time interval less than or equal to 0.6 seconds from the end of the step of degassing of the container (2).

7. A machine (1) for manufacturing containers (2) made of plastic material, the machine comprising:
a forming unit (3) for forming the containers (2) with at least one blowing station comprising at least one mold (31);
thermal image acquisition device (4) positioned at the output of the forming unit (3); and
a computing unit (5), connected to the thermal image acquisition device (4), the computing unit (5) being parameterized to implement the method as claimed in claim 1.

8. The machine (1) as claimed in claim 7, wherein the thermal image acquisition device (4) comprise a thermal camera.

9. The machine (1) as claimed in claim 6, wherein the forming unit (3) comprises a plurality of molds (31) for forming the containers (2), the computing unit (5) being parameterized to associate each container (2) with one of the molds (31) and generate an alert to an operator in the event of a container (2) considered as unacceptable, said alert including in particular association information making it possible to determine in which of the molds (31) of the forming unit (3) a container (2) considered as unacceptable was manufactured.

10. The machine (1) as claimed in claim 9, further comprising a dialogue interface (6) with an operator, the dialogue interface (6) allowing the display of the alert generated by the computing unit (5).

11. The method as claimed in claim 2, wherein the predetermined threshold temperature is 60°.

12. The method as claimed in claim 2, further comprising generating an alert to an operator if a container (2) considered as unacceptable is identified.

13. The method as claimed in claim 3, further comprising generating an alert to an operator if a container (2) considered as unacceptable is identified.

14. The method as claimed in claim 2, wherein the capturing a thermal image of the container (2) on leaving the mold (31) is performed within a time interval less than or equal to 5 seconds from the end of the step of degassing of the container (2), which occurs on completion of the manufacturing of the container (2).

15. The method as claimed in claim 3, wherein the capturing a thermal image of the container (2) on leaving the mold (31) is performed within a time interval less than or equal to 5 seconds from the end of the step of degassing of the container (2), which occurs on completion of the manufacturing of the container (2).

16. The method as claimed in claim 4, wherein the capturing a thermal image of the container (2) on leaving the mold (31) is performed within a time interval less than or equal to 5 seconds from the end of the step of degassing of the container (2), which occurs on completion of the manufacturing of the container (2).

17. The machine (1) as claimed in claim 7, wherein the forming unit (3) comprises a plurality of molds (31) for forming the containers (2), the computing unit (5) being parameterized to associate each container (2) with one of the molds (31) and generate an alert to an operator in the event of a container (2) considered as unacceptable, said alert including in particular association information making it possible to determine in which of the molds (31) of the forming unit (3) a container (2) considered as unacceptable was manufactured.
